(19) United States
(12) Patent Application Publication
(10) Pub. No.: US 2015/0170027 A1
(43) Pub. Date: Jun. 18, 2015

(54) NEURONAL DIVERSITY IN SPIKING NEURAL NETWORKS AND PATTERN CLASSIFICATION

(71) Applicant: QUALCOMM Incorporated, San Diego, CA (US)

(72) Inventors: Vikram GUPTA, San Diego, CA (US); Jeffrey Alexander LEVIN, San Diego, CA (US); Edward Hanyu LIAO, San Diego, CA (US)

(21) Appl. No.: 14/526,304

(22) Filed: Oct. 28, 2014

Related U.S. Application Data
(60) Provisional application No. 61/916,030, filed on Dec. 13, 2013.
(60) Provisional application No. 61/916,062, filed on Dec. 13, 2013.

(51) Int. Cl. G06N 3/08

(52) U.S. Cl. CPC G06N 3/08

(57) ABSTRACT

A method for providing diversity in a set of neurons in a neuron model includes retrieving a set of parameters for the set of neurons. The method also includes perturbing the set of parameters based on a neuron identification value, a level of perturbation for each parameter and/or parameter values.

### CROSS-REFERENCE TO RELATED APPLICATION

The present application claims the benefit of U.S. Provisional Patent Application No. 61/916,030, filed on Dec. 13, 2013, titled “NEURONAL DIVERSITY IN SPIKING NEURAL NETWORKS AND PATTERN CLASSIFICATION,” and U.S. Provisional Patent Application No. 61/916,062, filed on Dec. 13, 2013, titled “NEURONAL DIVERSITY IN SPIKING NEURAL NETWORKS AND PATTERN CLASSIFICATION,” the disclosures of which are expressly incorporated by reference herein in their entireties.

### BACKGROUND

1. Field

Certain aspects of the present disclosure generally relate to neural system engineering and, more particularly, to systems and methods for providing neuronal diversity in a spiking neural network.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks.

In typical artificial neural networks, parallel processing may be achieved by connecting many neurons from a single layer to many neurons in another layer. Similar connectivity is observed in biology in the neo-cortex. The neurons belonging to a layer of the artificial neural networks may be configured with similar, if not identical parameters. Likewise, the neurons in a layer may be found to have a similar structure, (e.g., pyramidal neurons (triangular shaped structure), or basket neurons (basket shaped structure)). When using a spiking neural network, the input signal to each neuron of a layer may be differentiated by applying different delays to the inputs.

Diversity in synaptic delays is also observed in biology and may be useful when the input signal uses temporal coding. However, simply varying synaptic delays may not utilize the rich non-linear neuronal dynamics. Viewing from a signal processing point of view, having different synaptic delays may only shift the incoming signal temporally, but may not modulate these signals in any manner. However, if the neurons in the output layer of the network were to spike for different inter-spike intervals between the two incoming spikes, or spike at different times even when the spikes are received exactly at the same time, the output from these two neurons will be quite different. Such neurons may provide a much richer level of signal processing than what is possible if both had exactly the same parameters.

### SUMMARY

In an aspect of the present disclosure, a method for providing diversity in a set of neurons in a neuron model is disclosed. The method includes retrieving a set of parameters for the set of neurons. The method also includes perturbing the set of parameters based on a neuron identification value, a level of perturbation for each parameter and/or parameter values.

In another aspect of the present disclosure, an apparatus for providing diversity in a set of neurons in a neuron model is disclosed. The apparatus includes a memory and one or more processors coupled to the memory. The processor(s) is(are) configured to retrieve a set of parameters for the set of neurons. The processor(s) is(are) also configured to perturb the set of parameters based on a neuron identification value, a level of perturbation for each parameter and/or parameter values.

In yet another aspect of the present disclosure, an apparatus for providing diversity in a set of neurons in a neuron model is disclosed. The apparatus includes means for retrieving a set of parameters for the set of neurons. The apparatus also includes means for perturbing the set of parameters based on a neuron identification value, a level of perturbation for each parameter and/or parameter values.

In still another aspect of the present disclosure, a computer program product for providing diversity in a set of neurons in a neuron model is presented. The computer program product includes a non-transitory computer readable medium having encoded thereon program code. The program code includes program code to retrieve a set of parameters for the set of neurons. The program code also includes program code to perturb the set of parameters based on a neuron identification value, a level of perturbation for each parameter and/or parameter values.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 illustrates an example implementation of designing a neural network using a general-purpose processor in accordance with certain aspects of the present disclosure.

FIG. 6 illustrates an example implementation of designing a neural network where a memory may be interfaced with individual distributed processing units in accordance with certain aspects of the present disclosure.

FIG. 7 illustrates an example implementation of designing a neural network based on distributed memories and distributed processing units in accordance with certain aspects of the present disclosure.

FIG. 8 illustrates an example implementation of a neural network in accordance with certain aspects of the present disclosure.

FIG. 9A is a block diagram illustrating an exemplary neural network implementing neural diversity in accordance with aspects of the present disclosure.

FIG. 9B illustrates spike time diversity and weight diversity in accordance with aspects of the present disclosure.

FIG. 10 is a block diagram illustrating an exemplary neural network using neural diversity to provide pattern classification in accordance with aspects of the present disclosure.

FIG. 11 illustrates a method for providing neuronal diversity in a set of neurons in accordance with aspects of the present disclosure.

FIG. 12 illustrates a method for pattern recognition in a spiking neural network in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

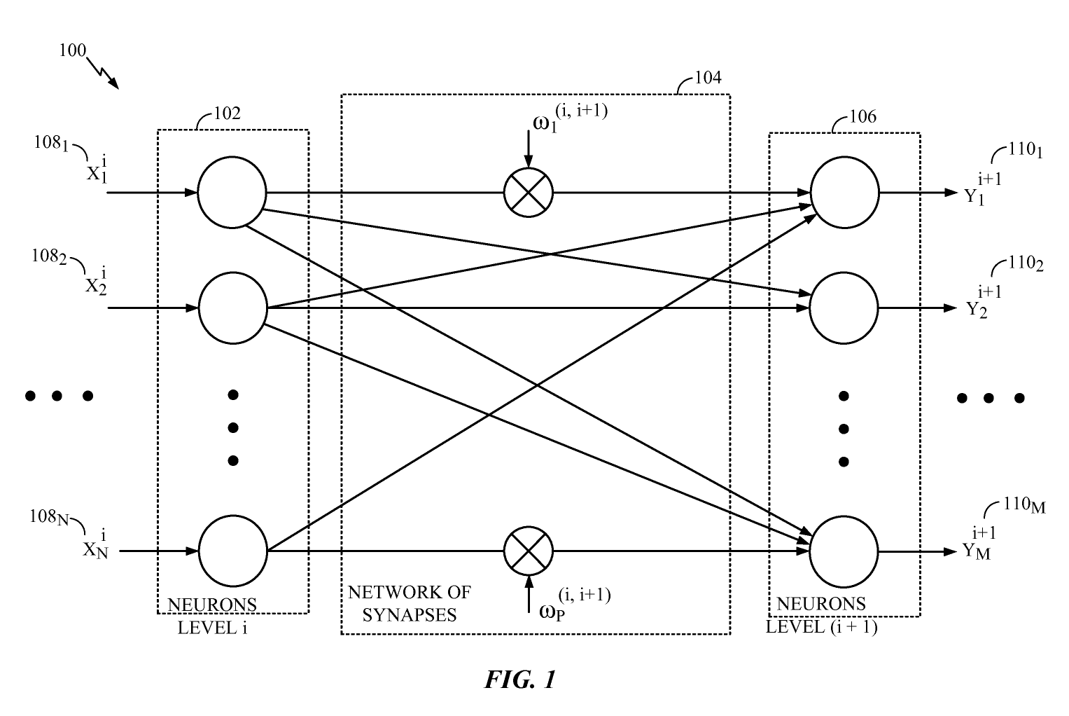

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

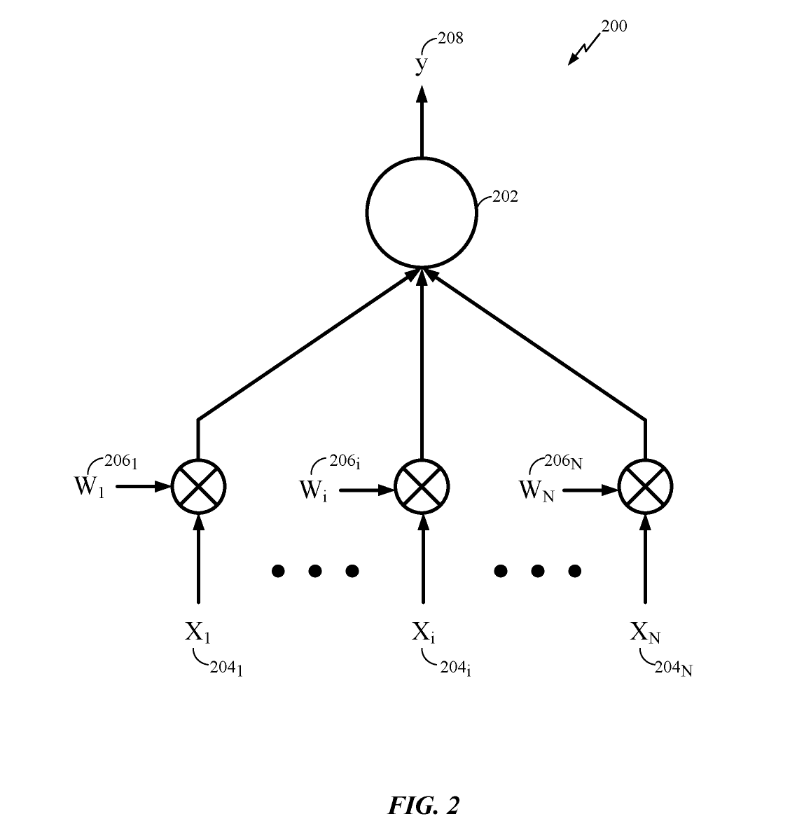

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , & t > 0 \\ {a}_{-} {e}^{t / {k}_{-}} , & t < 0\end{matrix} , \qquad ( 1 )$$

where k₊ and k₋ τ_{sign(Δt)} are time constants for positive and negative time difference, respectively, a₊ and a₋ are corresponding scaling magnitudes, and μ is an offset that may be applied to the positive time difference and/or the negative time difference.

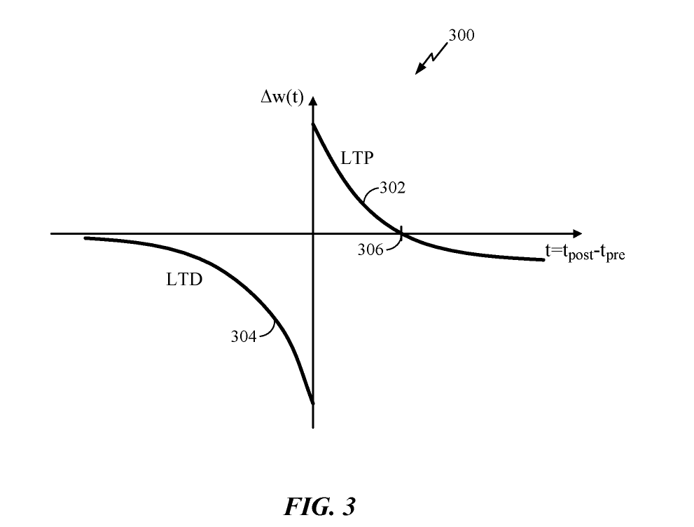

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) , & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

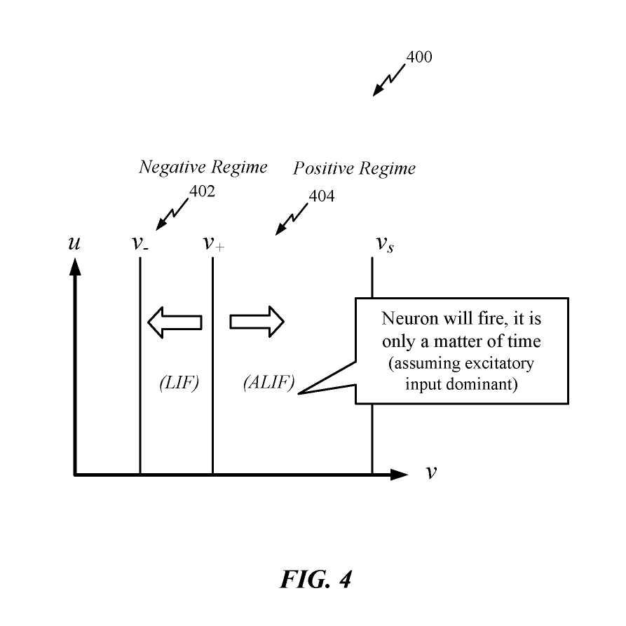

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r , & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε), (8)

where δ, ε, β and v, v_{|} are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value v_{S}. Subsequently, the state may be reset at a reset event (which may be one and the same as the spike event):

v=\hat{v}₋ (9)

u=u+Δu, (10)

where \hat{v}₋ and Δu are parameters. The reset voltage \hat{v}₋ is typically set to v₋.

By a principle of momentary coupling, a closed form solution is possible not only for state (and with a single exponential term), but also for the time to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r . & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} . \qquad ( 13 )$$

If a spike is defined as occurring at the time the voltage state v reaches v_{S}, then the closed-form solution for the amount of time, or relative delay, until a spike occurs as measured from the time that the voltage is at a given state v is:

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Neuronal Diversity and Pattern Classification

Aspects of the present disclosure are directed to providing neuronal diversity (e.g., in hardware and neural simulation tools). In one aspect, a value of a neuron parameter may be perturbed across a set or population of neurons based on the value of the parameter.

In accordance with an exemplary aspect of the present disclosure, neurons may be used to implement neuronal diversity. In this exemplary aspect of the present disclosure, neurons based on the piecewise linear neuron model are used for ease of explanation. This model may provide an efficient implementation of any two-dimensional neuron model. However, other neural models such as the COLD neural model, the Izhikevich (IZ) neural model and the like may also be used directly. Neuron models that utilize larger number of states, such as the Hodgkin-Huxley model or similar number of states such as the Morris-Lecar model or smaller number of states, such as the Leaky Integrate and Fire (LIF) models may also be used.

Neuronal diversity may be increased by adjusting neural parameters. In one aspect, a percentage range (e.g., +/−20%) of perturbation around a mean value of the parameter may be specified. For example, the resting membrane potential vᵣₑₛₜ may be perturbed within a +/−20% range of a mean value for the resting membrane potential vᵣₑₛₜ.

In a second example, a parameter τ₋ may be perturbed for a set of COLD neurons. Parameter τ₋ is the time constant of the decay of the membrane potential to the resting potential vᵣₑₛₜ. In this example, τ₋ may be perturbed such that each neuron potentially uses a slightly different τ₋ parameter value than another neuron in the set.

In some aspects, the membrane potential v and the recovery variable u may be adjusted to increase neuronal diversity. In some aspects, a table of coefficients used in the update equations for v and u (e.g., HVV, HVU, HVI, HVC, HUV, HUU, HUI, and HUC) may be constructed. This may be beneficial as the coefficients alone may be stored, thus enabling efficient processing because different values of parameters may be computed without being stored.

The coefficients may be stored for different ranges of the recovery variable v. For example, for a COLD neuron, two different values for the coefficient HVV may be used. With respect to the LIF model, one value may be used for the leaky integrate and fire (LIF) regime and another value may be used for anti-leaky integrate and fire (ALIF) regime. In some aspects, the value for these coefficients may be computed based on the neuron model parameters.

To increase neuronal diversity, perturbation may be applied to the coefficients for the update equations. For instance, in some aspects, the coefficients for membrane potential v and/or the recovery variable u may be subjected to random perturbations. In one example, the random perturbation may be applied to a neural class for which diversity is desired as follows:

random_div_bits[8]={9,8,7,0,9,7,7,0} (15)

In this example, the random diversity bits (random_div_bits[0-7] bits) may respectively correspond to perturbation applied to coefficients HVV, HVU, HVI, HVC, HUV, HUU, HUI, and HUC. Of course, the values of the random div bits [0-7] are merely exemplary and not limiting.

In a further example, the perturbation may be applied to the HVV coefficient as follows:

HVV_div=HVV+salt*HVV/2̂(16-random_div_bits) (16)

where salt may be a random number between −1 and 1. In some aspects, the salt value may be computed or generated at every tau (τ) for each neuron using a neuron identifier (id) as a key for a hash function. In other aspects, the salt value may be computed or generated at events where a neuron state is updated. Thus, the salt value for a given neuron may remain constant for the duration of a simulation. This may be advantageous as the costly expense of storing different H parameters may be reduced.

The random diversity bits (random_div_bits) may be used to control the level of diversity on the H value (e.g., HVV or HUI). For example, using a value of 9 may cause the H value to be perturbed by a fraction of its value, where the fraction is chosen randomly from the range [− 1/128, 1/128].

The level of diversity or perturbation may be controlled in any number of ways. For example, in some aspects, the level of perturbation may be controlled based on network behavior, input statistics (e.g., temporal jitter, spurious spikes, background noise level, drop in spikes), desired output, a desired probability distribution, a level of diversity in spike time, a level of diversity in synaptic weights, or other network and/or behavior metrics.

As such, aspects of the present disclosure may beneficially enable a user to control the level of diversity on each H value (i.e., coefficient) individually. For example, perturbing one H value (e.g., HVV) may be sufficient to provide a desired level of neuronal diversity, such that diversity on other H values (e.g., HVI, HUU and HUI) is not implemented. As such, in accordance with aspects of the present disclosure, neuronal parameters (e.g., HVV, HVU, HVI, HVC, HUV, HUU, HUI, and HUC) may be perturbed individually or in combination with varying degrees of perturbation. Thus, the impact on each parameter may be different.

In some aspects, the neural parameter perturbed may impact the states of the neuron population. In one example, the HVV parameter value may be based on τ₊ and τ₋ values, depending on ALIF or LIF regimes, respectively. Parameters τ₊ and τ₋ are the time constants of the membrane potential. The firing rate across the population of the output layer neurons with different levels of perturbation may be uniformly distributed with HVV perturbation, and the range of the distribution may increase with level of diversity. Moreover, in the LIF regime, this parameter allows output layer neurons to spike with different levels of input activity. Thus, some neurons with smaller values of τ₋ may spike only with higher coincident input, while others with larger values of τ₋ may spike with only a small degree of coincident inputs.

As such, in some aspects, neuronal diversity may be increased by adjusting the τ₋ parameter. That is, because τ₋ controls the rate at which the membrane potential will decay to resting potential, by varying τ₋, neurons may be made less or more excitable to input.

In some aspects, parameter sweeps may be conducted to determine the parameters, range of values and the like that may further improve or even optimize neuronal diversity and performance of the neural network. The parameter sweep may also be used to determine whether one method of providing diversity (e.g., applying random diversity bits) produces improved performance characteristics over another method of providing diversity (e.g., dithering the least significant bit of a parameter). The parameters deemed to provide improved performance may be stored and used to train the neural network.

In another exemplary aspect, neuronal diversity may be increased across a set or population of neurons by applying a perturbation to a portion of a neuron parameter (e.g., H value(s)). For example, neuronal diversity may be increased by adding/subtracting a salt value that is unique to an individual neuron to some specified least significant bits (LSBs) of the H value. This approach allows a user to choose a level of perturbation that is not proportional to the H value. Further, additional calculation may achieve a zero-mean perturbation around ideal values.

Increased neuronal diversity in accordance with aspects of the present disclosure may be advantageous and broadly applicable. In some aspects, by controlling neuronal diversity, the firing rate across a population of neurons may likewise be controlled. For example, the firing rate of a population of 100 neurons receiving identical input from 1000 neurons may be varied using neuronal diversity.

In one application of neuronal diversity, learning of temporal patterns is made more robust to initial network conditions. For example, the network may be configured to learn to detect patterns in presence of noise in the form of spurious spikes, dropped spikes, or temporal jitter in spike timing in the pattern. The noise can be present in training as well as during a testing phase. It should be appreciated that training a network in the presence of spurious spikes, dropped spikes, or temporal jitter in spike timing in the pattern enables correct classification of real world patterns where parts of a signal may be missing (e.g., object may be occluded), noise signals may be present with the signal of interest (e.g., background image along with an object of interest), or temporal jitter may be present in the spike representation of the object (e.g., blurry object).

In another exemplary aspect of the present disclosure, diversity in spike latency may also be enhanced across a population of neurons when these neurons receive identical inputs.

Furthermore, aspects of the present disclosure may complement other mechanisms, such as the use of random weights and random delays on synapses connecting the input layer to the output layer. For example, when used in conjunction with spike timing-dependent plasticity (STDP), the bi-modality in distribution of weights may be reduced thereby making the learning more robust to stochasticity in synaptic firing or loss of synapses. In addition, performing parameter sweeps across different sets of neuronal parameters may also be improved.

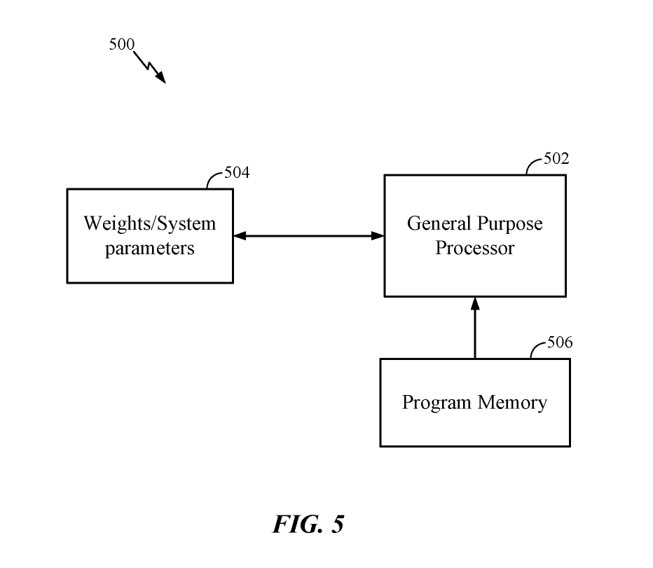

FIG. 5 illustrates an example implementation 500 of the aforementioned providing neuronal diversity and pattern recognition using a general-purpose processor 502 in accordance with certain aspects of the present disclosure. Variables (neural signals), synaptic weights, system parameters associated with a computational network (neural network), delays, frequency bin information and neural parameters may be stored in a memory block 504, while instructions executed at the general-purpose processor 502 may be loaded from a program memory 506. In an aspect of the present disclosure, the instructions loaded into the general-purpose processor 502 may comprise code for retrieving a set of parameters for the set of neurons and/or perturbing the set of parameters based on a neuron identification, level of perturbation and/or parameter value.

In another aspect of the present disclosure, the instructions loaded into the general-purpose processor 502 may comprise code for creating a set of diverse neurons in a first layer, presenting an input corresponding to a pattern plus noise at an input layer, representing the input as spikes, receiving the spikes at the first layer, spiking at the first layer based on the received spikes, updating a weight of each synapses between input layer neuron and output layer neuron based on spike timing difference between a spike at the input layer neuron and a spike at an output layer neuron, and classifying a spike pattern represented by a set of inter-spike intervals, regardless of noise in the spike pattern.

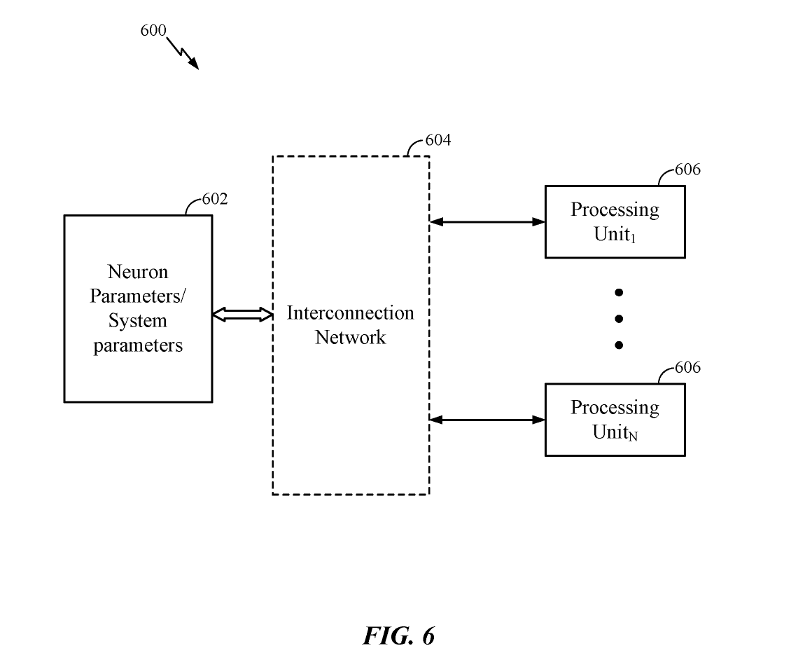

FIG. 6 illustrates an example implementation 600 of the aforementioned providing neuronal diversity and pattern recognition where a memory 602 can be interfaced via an interconnection network 604 with individual (distributed) processing units (neural processors) 606 of a computational network (neural network) in accordance with certain aspects of the present disclosure. Variables (neural signals), synaptic weights, system parameters associated with the computational network (neural network) delays, frequency bin information, and neural parameters may be stored in the memory 602, and may be loaded from the memory 602 via connection(s) of the interconnection network 604 into each processing unit (neural processor) 606. In an aspect of the present disclosure, the processing unit 606 may be configured to retrieve a set of parameters for the set of neurons and/or perturb the set of parameters based on a neuron identification, level of perturbation and/or parameter value.

In another aspect of the present disclosure, the processing unit 606 may be configured to create a set of diverse neurons in a first layer, present an input corresponding to a pattern plus noise at an input layer, represent the input as spikes, receive the spikes at the first layer, spike at the first layer based on the received spikes, update a weight of each synapses between input layer neuron and output layer neuron based on spike timing difference between a spike at the input layer neuron and a spike at an output layer neuron, and classify a spike pattern represented by a set of inter-spike intervals, regardless of noise in the spike pattern.

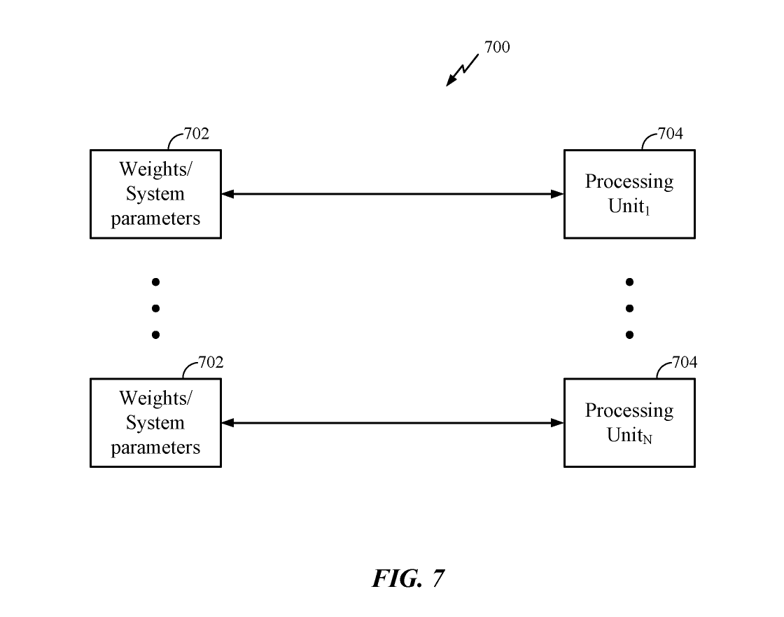

FIG. 7 illustrates an example implementation 700 of the aforementioned providing neuronal diversity and pattern recognition. As illustrated in FIG. 7, one memory bank 702 may be directly interfaced with one processing unit 704 of a computational network (neural network). Each memory bank 702 may store variables (neural signals), synaptic weights, and/or system parameters associated with a corresponding processing unit (neural processor) 704 delays, frequency bin information, and neuronal parameters. In an aspect of the present disclosure, the processing unit 704 may be configured to retrieve a set of parameters for the set of neurons and/or perturb the set of parameters based on a neuron identification, level of perturbation and/or parameter value.

In another aspect of the present disclosure, the processing unit 704 may be configured to create a set of diverse neurons in a first layer, present an input corresponding to a pattern plus noise at an input layer, and represent the input as spikes, receive the spikes at the first layer. The processing unit 704 is also configured to spike at the first layer based on the received spikes, update a weight of each synapses between input layer neuron and output layer neuron based on spike timing difference between a spike at the input layer neuron and a spike at an output layer neuron, and classify a spike pattern represented by a set of inter-spike intervals, regardless of noise in the spike pattern.

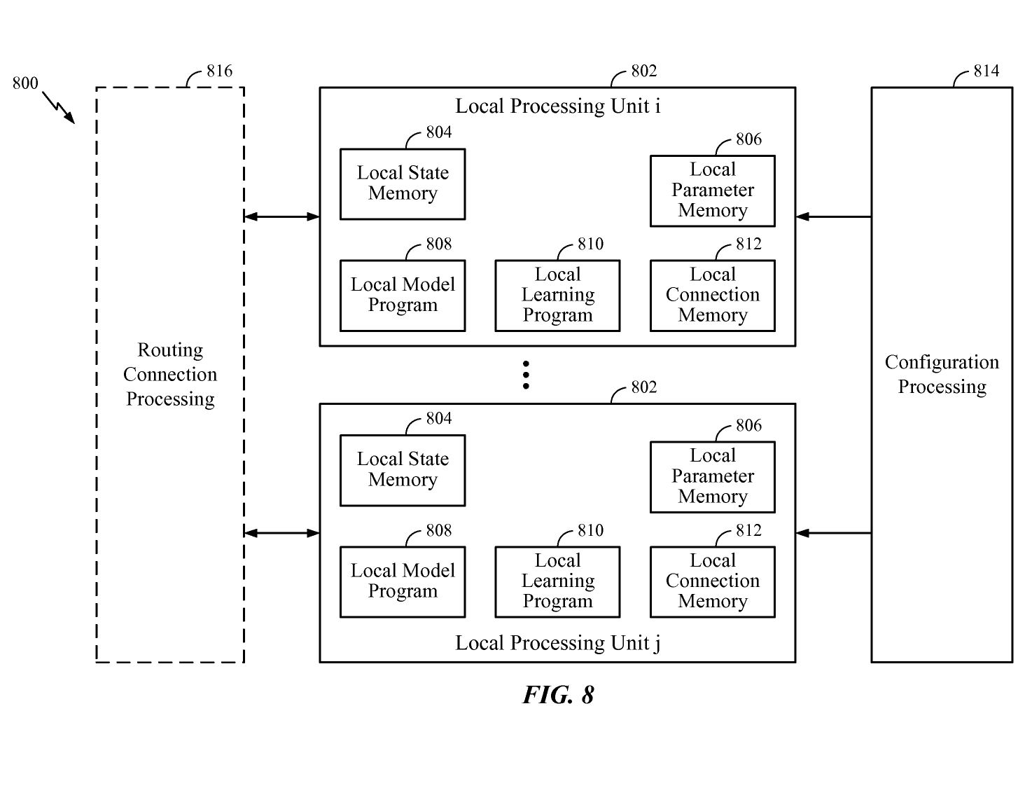

FIG. 8 illustrates an example implementation of a neural network 800 in accordance with certain aspects of the present disclosure. As illustrated in FIG. 8, the neural network 800 may have multiple local processing units 802 that may perform various operations of methods described in the present disclosure. Each local processing unit 802 may comprise a local state memory 804 and a local parameter memory 806 that store parameters of the neural network. In addition, the local processing unit 802 may have a local (neuron) model program (LMP) memory 808 for storing a local model program, a local learning program (LLP) memory 810 for storing a local learning program, and a local connection memory 812. Furthermore, as illustrated in FIG. 8, each local processing unit 802 may be interfaced with a configuration processor unit 814 for providing configurations for local memories of the local processing unit, and with a routing unit 816 that provide routing between the local processing units 802.

In one configuration, a neuron model is configured for providing neuronal diversity. The neuron model includes a retrieving means and perturbing means. In one aspect, the retrieving means and/or perturbing means may be the general-purpose processor 502, program memory 506, memory block 504, memory 602, interconnection network 604, processing units 606, processing unit 704, local processing units 802, and or the routing connection processing elements 816 configured to perform the functions recited. In another configuration, the aforementioned means may be any module or any apparatus configured to perform the functions recited by the aforementioned means.

In another configuration, a neuron model is configured for pattern recognition. The neuron model includes a creating means, presenting means, receiving means, spiking means, updating means, and/or classifying means. In one aspect, the creating means, presenting means, receiving means, spiking means, updating means, and/or classifying means may be the general-purpose processor 502, program memory 506, memory block 504, memory 602, interconnection network 604, processing units 606, processing unit 704, local processing units 802, and or the routing connection processing elements 816 configured to perform the functions recited. In another configuration, the aforementioned means may be any module or any apparatus configured to perform the functions recited by the aforementioned means.

According to certain aspects of the present disclosure, each local processing unit 802 may be configured to determine parameters of the neural network based upon desired one or more functional features of the neural network, and develop the one or more functional features towards the desired functional features as the determined parameters are further adapted, tuned and updated.

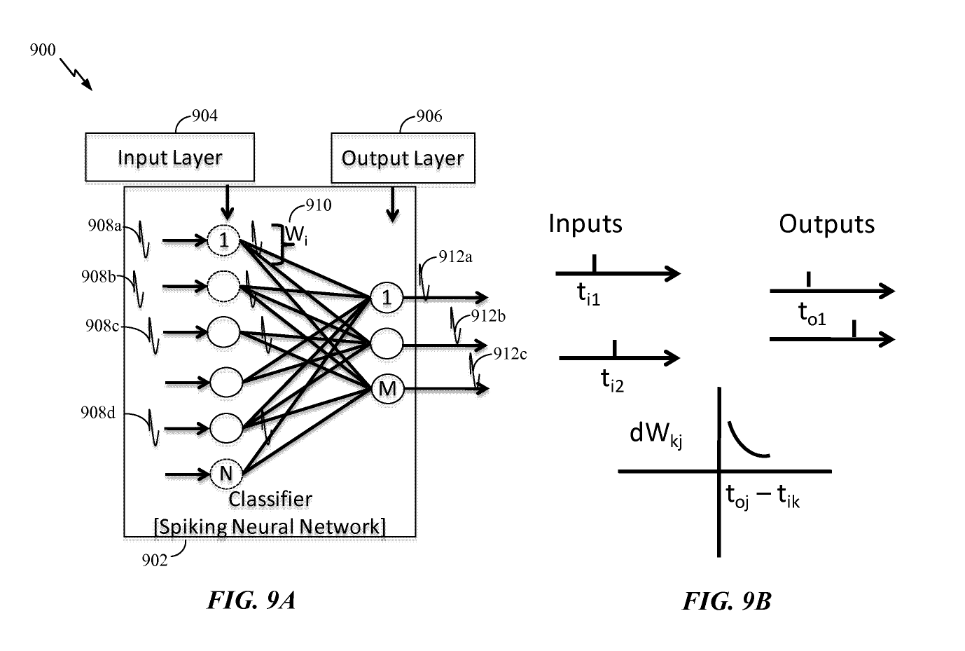

FIG. 9A is a block diagram illustrating an exemplary neural network 900 implementing neural diversity in accordance with aspects of the present disclosure. Referring to FIG. 9A, the exemplary neural network is configured as a spiking neural network. The neural network 900 includes a classifier 902. The classifier may be configured with an input layer 904 and an output layer 906. Parameters of the neurons in the input layer and/or the output layer may be perturbed to implement neuronal diversity. Although the classifier of FIG. 9A includes two layers, this is merely exemplary, for ease of illustration and explanation, and not limiting.

The input layer 904 and output layer 906 may be coupled together via synaptic connections 910. In some aspects, the synaptic connections 910 may be configured such that the neurons of the input layer 904 and neurons of the output layer 906 may be connected in an all-to-all fashion. By virtue of the all-to-all connectivity between inputs and output layer neurons, each of the neurons of the output layer 906 may receive similar inputs (e.g., the same inputs). As such, spikes (e.g., 908a, 908b, 908c, and 908d) received at the input layer 904 may present the same input to each of the neurons of the output layer 906. However, because of the implemented neuronal diversity, the output layer neurons may generate a spike (912a, 912b, 912c) at different times.

In some aspects, diversity may also be applied to the weights of synaptic connections 910 in a manner similar to that described above with respect to neurons. For example, a weight (e.g., Wᵢ) of one or more of the synaptic connections 910 or synapses connecting two neurons may be a function of the spike timing difference (e.g., spike timing-dependent plasticity (STDP)). Applying diversity, the spike timings may be made diverse and in turn, the weight updates for the synaptic connections 910 may be made diverse.

As shown in FIG. 9B, by applying diversity, output spike timings to₁ and tₒ₂ may be made diverse. The weight updates on the synapses connecting the k^{th} input layer neuron and j^{th} output layer neuron may be based on difference in the spike timings tₒⱼ−tᵢₖ. An exemplary schematic function is shown in FIG. 9B. In the exemplary schematic, the weight update (dW) is positive for a causal input spike and negative for a non-causal input spike. Further, the higher the coincidence, (or the smaller the difference in spike times), the larger the magnitude of the weight update (dW). Thus, when output layer spike timings are made diverse across different output layer neurons using neuronal diversity, the weight updates on synapses connecting an input layer neuron to different output layer neurons may also be made diverse if the weight update function is not a constant.

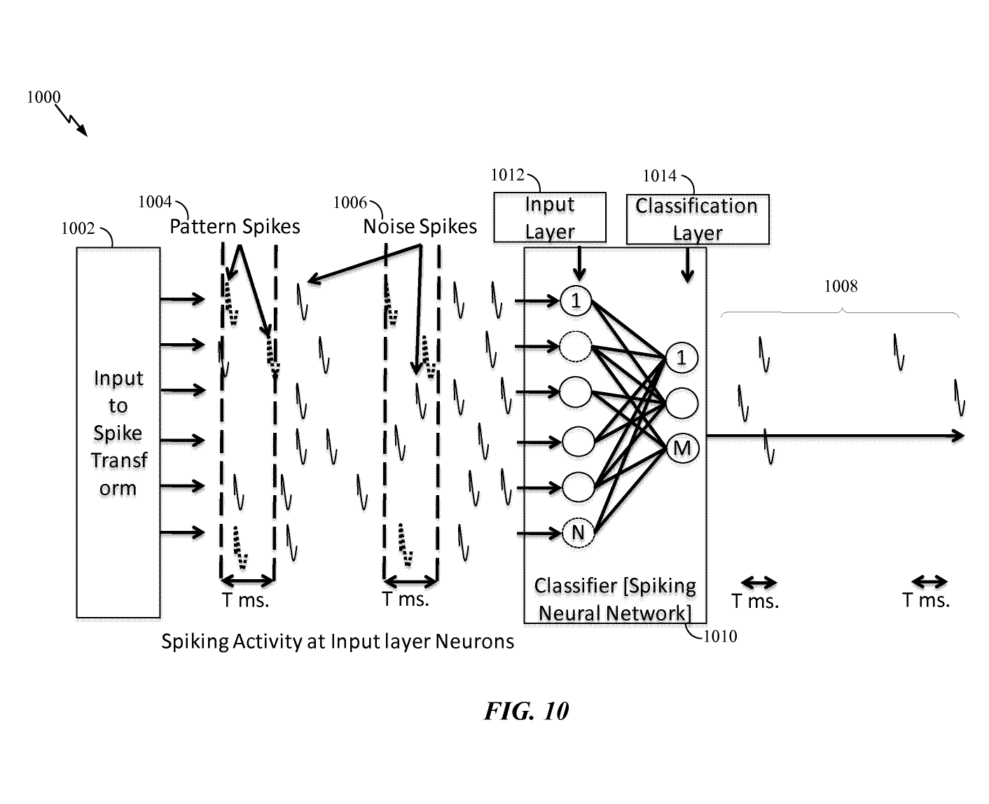

FIG. 10 is a block diagram illustrating an exemplary neural network 1000 using neural diversity in accordance with aspects of the present disclosure. Referring to FIG. 10, the neural network is configured for pattern classification. The neural network includes a classifier 1010 having an input layer 1012 and a classification layer 1014. Inputs may be supplied to the classifier via input 1002, which may convert an input to spikes, for example. A pattern of spikes (e.g., 1004) in the presence of noise spikes 1006 may be presented to the input layer 1012 of the classifier.

A set of neurons in the input layer 1012 and/or the classification layer 1014 may be configured as diverse set by applying diversity. In some aspects, the spike timing may also be made diverse. As such, weight of the synaptic connection between a neuron of the input layer 1012 and a neuron of the classification layer 1014 may be updated such that the classifier 1010 may learn to generate spikes when a pattern (e.g., represented by spikes 1004) is presented at the classification layer 1014.

In some aspects, the pattern classification may be based on inter-spike intervals between the spikes representing the pattern. In this case, spikes representing the pattern are presented during an interval T ms (e.g., 100 ms). That is, the pattern is represented by the inter-spike interval for spikes 1004 during the T ms. As such, the neurons of the classification layer 1014 may be trained to generate spikes according to the inter-spike interval between pattern spikes 1004 during T ms of pattern input. Thus, neurons of the classification layer 1014 may generate spikes 1008 at timings corresponding to the pattern presentation interval (e.g., T ms), and in doing so, a pattern may be classified even in the presence of noise.

In one example, the pattern classification may be achieved by learning weights on the synapses connecting the input layer and the output layer of the neural network 1010 such that the output layer neurons generate a spike only when the pattern is presented at the input layer and not otherwise. When output layer neurons have diverse parameters and spike at different times for the same input, for certain synaptic weight update functions, the weights are updated such that neurons spike for different (possibly non-contiguous) parts of the pattern. For example, when the membrane potential decay time constant at the output layer neuron is large, the first few spikes of the input spike pattern may be sufficient to cause a spike at the output layer neuron. Similarly, when the membrane potential decay time constant at the output layer neuron is small, only a coincident part of the input spike pattern may cause a spike at the output layer neuron. The diversity in spike times and the resulting diversity in weight updates allows distortions around the ideal pattern to be detected. For instance, if parts of the pattern are missing, or if the inter spike interval between the spikes representing the spikes are jittered (e.g., due to blurry input), the diversity in weights allows the output layer to still generate spiking outputs for the input pattern and enable detection.

By implementing diversity, the classifier is able to detect portions of a pattern rather than merely detecting the earliest part of a pattern that results in a classification. For example, a numerical classifier configured without diversity may not be able to distinguish a number ‘3’ from a number ‘8’ given the similar form. As a result, misclassification errors may be incurred. However, by implementing neuronal diversity, all subparts of the pattern may be used to determine the classification, thereby reducing misclassification errors.

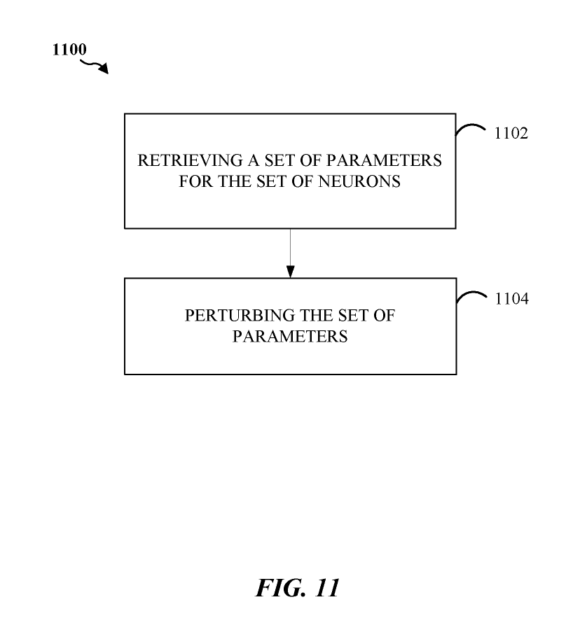

FIG. 11 illustrates a method 1100 for providing neuronal diversity in a set of neurons. In block 1102, the neuron model retrieves a set of parameters for the set of neurons. Furthermore, in block 1104, the neuron model perturbs the set of parameters based on a neuron identification value, level of perturbation for each parameter and/or parameter value.

In some aspects, the set of parameters may be perturbed based on a percentage range of perturbation around a mean value of one or more parameter values in the set. In other aspects, the set of parameters may be perturbed by dithering a least significant bit of a parameter value for a portion of the set of neurons.

The level of perturbation for each parameter and or parameter value may also be controlled. In some aspects, the level of perturbation may be based on network behavior and input statistics. For example, the level of perturbation may be selected based on the presence of spurious spikes, temporal jitter, background noise and or a drop in input spikes or the like. Further, in some aspects, the level of perturbation may be based on a desired output, a desired probability distribution and/or a level of diversity in spike time or synaptic weight.

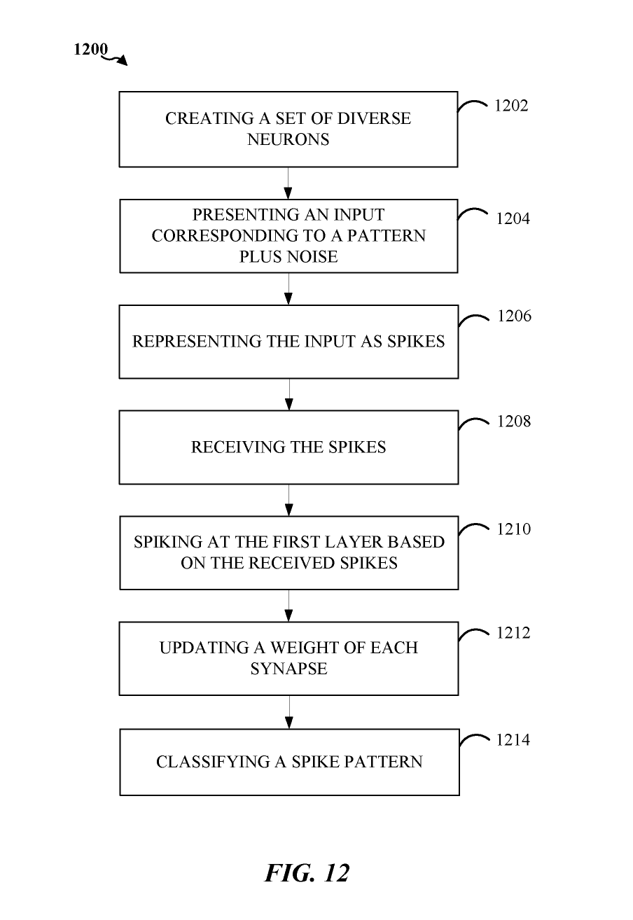

FIG. 12 illustrates a method 1200 for pattern recognition in a spiking neural network. In block 1202, the neuron model creates a set of diverse neurons in a first layer to increase diversity in a set of spike timings. In some aspects, the first layer may comprise a classification layer or an intermediate layer.

In block 1204, the neuron model presents an input corresponding to a pattern plus noise at an input layer. The noise may include, for example, spurious spikes, dropped spikes, and/or temporal jitter in the spike pattern.

In block 1206, the neuron model represents the input as spikes. In block 1208, the neuron model receives the spikes at the first layer. In block 1210, the neuron model spikes at the first layer based on the received spikes.

In block 1212, the neuron model updates a weight for each synapse between an input layer neuron and output layer neuron based on spike timing differences between a spike at the input layer neuron and a spike at an output layer neuron. In some aspects, the weight is spike timing modulated with updates. The spike timing may be different in response to the same input. Further, in some aspects, a diverse set of weight updates may be achieved based on synapses between two layers for a same input.

In block 1214, the neuron model classifies a spike pattern represented by a set of inter-spike intervals, regardless of noise in the spike pattern.

In some aspects, the neuron model may further train synapses between the input layer and a classification layer based on the spike pattern and spike timing differences between two layers.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for providing diversity in a set of neurons in a neuron model comprising:
retrieving a set of parameters for the set of neurons; and
perturbing the set of parameters based at least in part on a neuron identification value, a level of perturbation for each parameter and/or parameter values.

2. The method of claim 1, in which the perturbing is based at least in part on a percentage range of perturbation around a mean value of at least one parameter value.

3. The method of claim 1, in which the perturbing includes dithering at least a significant bit of a parameter value for at least a portion of the set of neurons.

4. The method of claim 1, in which the level of perturbation of the set of parameters is based at least in part on network behavior and input statistics.

5. The method of claim 1, in which the level of perturbation of the set of parameters is based at least in part on desired output.

6. The method of claim 1, in which the perturbing is based at least in part on a desired probability distribution.

7. The method of claim 1, in which the level of perturbation of the set of parameters is based at least in part on a level of diversity in spike times.

8. The method of claim 1, in which the level of perturbation of the set of parameters is based at least in part on a level of diversity in synaptic weights.

9. An apparatus for providing diversity in a set of neurons in a neuron model comprising:
a memory; and
at least one processor coupled to the memory, the at least one processor being configured:
to retrieve a set of parameters for the set of neurons; and
to perturb the set of parameters based at least in part on a neuron identification value, a level of perturbation for each parameter and/or parameter values.

10. The apparatus of claim 9, in which the at least one processor is further configured to perturb the set of parameters based at least in part on a percentage range of perturbation around a mean value of at least one parameter value.

11. The apparatus of claim 9, in which the at least one processor is further configured to dither at least a significant bit of a parameter value for at least a portion of the set of neurons.

12. The apparatus of claim 9, in which the level of perturbation of the set of parameters is based at least in part on network behavior and input statistics.

13. The apparatus of claim 9, in which the level of perturbation of the set of parameters is based at least in part on desired output.

14. The apparatus of claim 9, in which the at least one processor is further configured to perturb the set of parameters based at least in part on a desired probability distribution.

15. The apparatus of claim 9, in which the level of perturbation of the set of parameters is based at least in part on a level of diversity in spike times.

16. The apparatus of claim 9, in which the level of perturbation of the set of parameters is based at least in part on a level of diversity in synaptic weights.

17. An apparatus for providing diversity in a set of neurons in a neuron model comprising:
means for retrieving a set of parameters for the set of neurons; and
means for perturbing the set of parameters based at least in part on a neuron identification value, a level of perturbation for each parameter and/or parameter values.

18. The apparatus of claim 17, in which the means for perturbing perturbs the set of parameters based at least in part on a percentage range of perturbation around a mean value of at least one parameter value.

19. The apparatus of claim 17, in which the means for perturbing dithers at least a significant bit of a parameter value for at least a portion of the set of neurons.

20. The apparatus of claim 17, in which the level of perturbation of the set of parameters is based at least in part on network behavior and input statistics.

21. The apparatus of claim 17, in which the level of perturbation of the set of parameters is based at least in part on desired output.

22. The apparatus of claim 17, in which the means for perturbing perturbs the set of parameters based at least in part on a desired probability distribution.

23. The apparatus of claim 17, in which the level of perturbation of the set of parameters is based at least in part on a level of diversity in spike times.

24. The apparatus of claim 17, in which the level of perturbation of the set of parameters is based at least in part on a level of diversity in synaptic weights.

25. A computer program product for providing diversity in a set of neurons in a neuron model comprising:
a non-transitory computer readable medium having encoded thereon program code, the program code comprising:
program code to retrieve a set of parameters for the set of neurons; and
program code to perturb the set of parameters based at least in part on a neuron identification value, a level of perturbation for each parameter and/or parameter values.

26. The computer program product of claim 25, further comprising program code to perturb the set of parameters based at least in part on a percentage range of perturbation around a mean value of at least one parameter value.

27. The computer program product of claim 25, further comprising program code to dither at least a significant bit of a parameter value for at least a portion of the set of neurons.

28. The computer program product of claim 25, in which the level of perturbation of the set of parameters is based at least in part on network behavior and input statistics.

29. The computer program product of claim 25, in which the level of perturbation of the set of parameters is based at least in part on desired output.

30. The computer program product of claim 25, further comprising program code to perturb the set of parameters based at least in part on a desired probability distribution.

31. The computer program product of claim 25, in which the level of perturbation of the set of parameters is based at least in part on a level of diversity in spike times.

32. The computer program product of claim 25, in which the level of perturbation of the set of parameters is based at least in part on a level of diversity in synaptic weights.
